(19) United States
(12) Patent Application Publication
(10) Pub. No.: US 2015/0146325 A1
(43) Pub. Date: May 28, 2015

(54) SUSPENSION ASSEMBLY, HEAD SUSPENSION ASSEMBLY, AND MAGNETIC DISK DRIVE

(71) Applicant: KABUSHIKI KAISHA TOSHIBA, Tokyo (JP)

(72) Inventor: Kazuyuki Mizuishi, Yokohama-shi (JP)

(73) Assignee: KABUSHIKI KAISHA TOSHIBA, Tokyo (JP)

(21) Appl. No.: 14/201,598

(22) Filed: Mar. 7, 2014

Related U.S. Application Data
(60) Provisional application No. 61/908,322, filed on Nov. 25, 2013.

(51) Int. Cl. G11B 5/48

(52) U.S. Cl. CPC G11B 5/486; G11B 5/4833
USPC 360/244.2

(57) ABSTRACT

According to one embodiment, a suspension assembly including a load beam and an electric wiring member is provided. The load beam has a thin plate-like shape that extends from a base part toward a distal end. The electric wiring member extends from the base part toward the distal end to be overlapped with a first surface of the load beam and includes a wire formed thereon. A protrusion that protrudes on the first surface side is provided at a position avoiding the electric wiring member on the load beam, as seen in a plan view.

### CROSS-REFERENCE TO RELATED APPLICATIONS

This application is based upon and claims the benefit of priority from U.S. Provisional Application No. 61/908,322, filed on Nov. 25, 2013; the entire contents of which are incorporated herein by reference.

### FIELD

Embodiments described herein relate generally to a suspension assembly, a head suspension assembly, and a magnetic disk drive.

### BACKGROUND

A head stack assembly for performing write and read of data to and from magnetic disks is provided in a magnetic disk drive. The head stack assembly includes a plurality of sliders embedded with head elements (a write element and a read element), and a plurality of suspension assemblies each formed in a thin plate shape. Write and read of data to and from magnetic disks is performed by the head elements. The sliders are provided at distal ends of the suspension assemblies, respectively. The suspension assemblies are provided in such a manner that surfaces provided with the sliders face each other.

As the capacity of the magnetic disk drive becomes high recently, demands for high reliability of the magnetic disk drive are increasing. As a part of improvement in the reliability of the magnetic disk drive, tightening of manufacturing lines of the magnetic disk drive and quality controls of the components is needed. For example, to suppress deterioration in reliability of the magnetic disk drive, it is required to avoid dust (contamination) being mixed in the magnetic disk drive as much as possible in a manufacturing process of the magnetic disk drive.

At the time of manufacture or in an inspection process of the head stack assembly thereof, to suppress contacts between the sliders, separators are inserted between load beams which are constituent members of suspensions to hold gaps between the sliders, respectively.

At the time of inserting the separators, dust (contamination) may be generated by frictions due to the contacts or slides between the separators and the load beams. Therefore, it is desired to suppress generation of dust (contamination) at the time of inserting the separators between the load beams.

### BRIEF DESCRIPTION OF THE DRAWINGS

FIG. 1 is a plan view illustrating schematic configuration of a magnetic disk drive according to a first embodiment;

FIG. 2 is a plan view illustrating schematic configuration of a head stack assembly;

FIG. 3 is a side view illustrating schematic configuration of the head stack assembly;

FIG. 4 is a plan view illustrating schematic configuration of a head suspension assembly;

FIG. 5 is a plan view illustrating schematic configuration of a load beam;

FIG. 6 is a sectional view taken in an arrow direction of a line A-A shown in FIG. 4;

FIGS. 7A and 7B illustrate schematic configurations of the head stack assembly, FIG. 7A is a partially enlarged view of a part B shown in FIG. 3; FIG. 7B is a partially enlarged sectional view of a part C shown in FIG. 7A;

FIG. 8 is a block diagram illustrating a functional configuration of the magnetic disk drive;

FIG. 9 illustrates a state where a separator is inserted between load beams in a head stack assembly shown as a comparative example;

FIG. 10 illustrates a state where a separator is inserted between load beams in a head stack assembly shown as another comparative example;

FIG. 11 illustrates a state where a separator is inserted between load beams in the head stack assembly according to the first embodiment;

FIG. 12 illustrates another state where the separator is inserted between load beams in the head stack assembly according to the first embodiment; and

FIGS. 13A and 13B illustrate modifications of a separation protrusion, FIG. 13A is a side view of a separation protrusion; FIG. 13B is a sectional view taken in an arrow direction of a line E-E shown in FIG. 13A.

### DETAILED DESCRIPTION

In general, according to one embodiment, a suspension assembly including a load beam and an electric wiring member is provided. The load beam has a thin plate-like shape that extends from a base part toward a distal end. The electric wiring member extends from the base part toward the distal end to be overlapped with a first surface of the load beam and includes a wire formed thereon. A protrusion that protrudes on the first surface side is provided at a position avoiding the electric wiring member on the load beam, as seen in a plan view.

Exemplary embodiments of a suspension assembly, a head suspension assembly, and a magnetic disk drive will be explained below in detail with reference to the accompanying drawings. The present invention is not limited to the following embodiments.

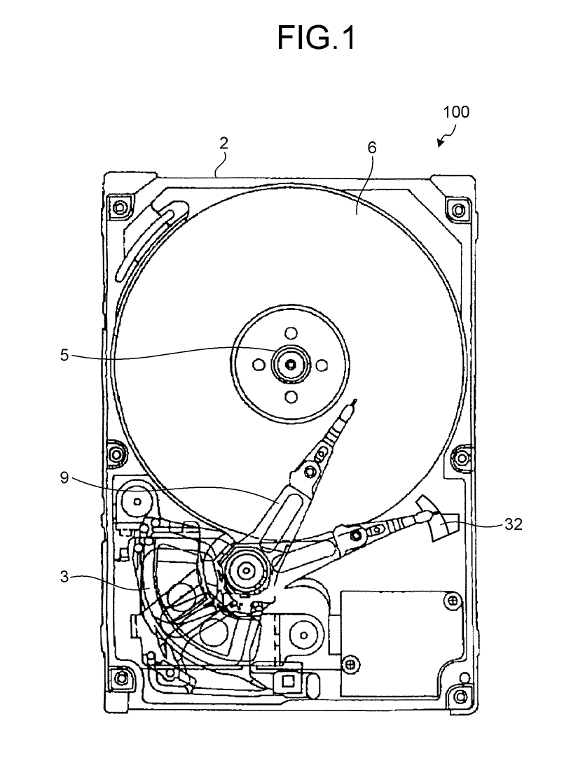

A schematic configuration of the magnetic disk drive is explained first. FIG. 1 is a plan view illustrating a magnetic disk drive according to a first embodiment. A magnetic disk drive 100 includes a case 2, magnetic disks 6, a spindle motor 5, a head stack assembly (HSA) 9, and a voice coil motor (VCM) (a drive unit) 3. The magnetic disks 6, the head stack assembly 9, and the voice coil motor 3 are housed in the case 2.

Each of the magnetic disks 6 is configured to include a magnetic recording layer in a substrate (a disk). The magnetic disk 6 has a size of 2.5 inches (6.35 centimeters), for example, and a plurality of (three, for example) magnetic disks 6 are provided in the case 2. The spindle motor 5 supports the magnetic disks 6. The spindle motor 5 rotates the magnetic disks 6.

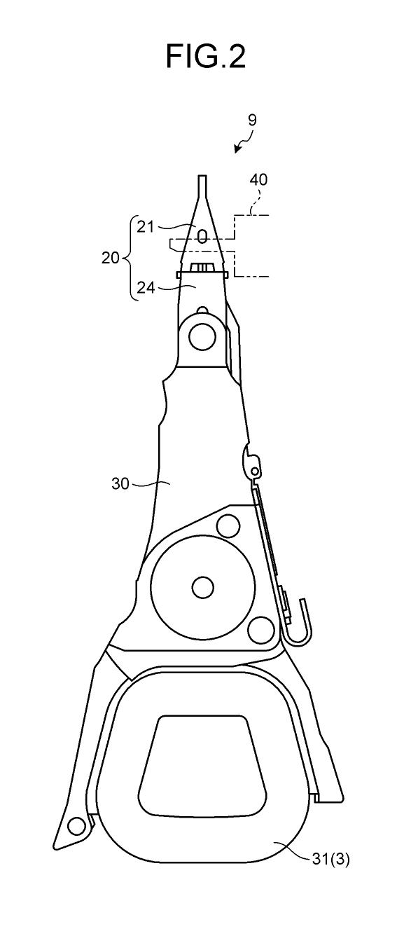

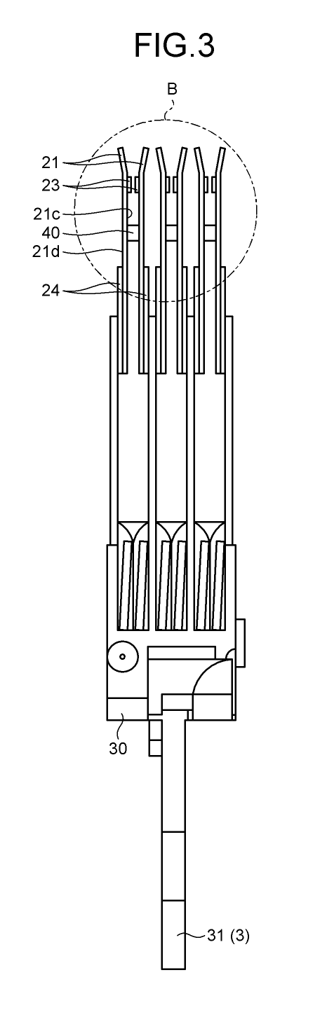

FIG. 2 is a plan view illustrating a schematic configuration of the head stack assembly 9. FIG. 3 is a side view illustrating the schematic configuration of the head stack assembly 9. The head stack assembly 9 includes an arm 30 and a plurality of head suspension assemblies 20 fixed to the arm 30. The head stack assembly 9 is provided with a plurality of sliders 23. The head stack assembly 9 moves the sliders 23 to desired positions on the magnetic disks 6 by the voice coil motor 3 in the case 2, respectively. Head elements (not shown) embedded in the sliders 23 write or read data to and from the magnetic disks 6, respectively.

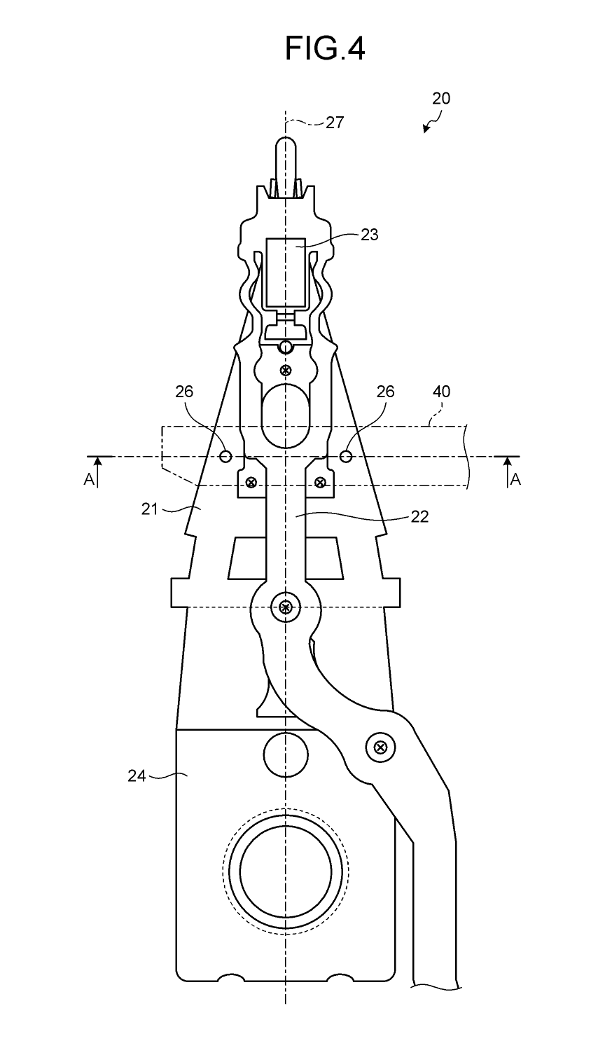

FIG. 4 is a plan view illustrating a schematic configuration of the head suspension assembly 20. The head suspension assembly 20 includes load beams 21, flexures (electric wiring members) 22, the sliders 23, and base plates 24. Among these, the load beams 21, the flexures 22, and the base plates 24 except for the sliders 23 constitute suspension assemblies, respectively.

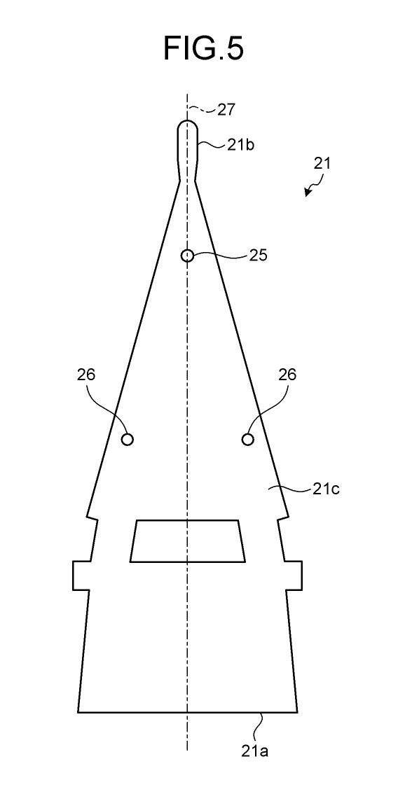

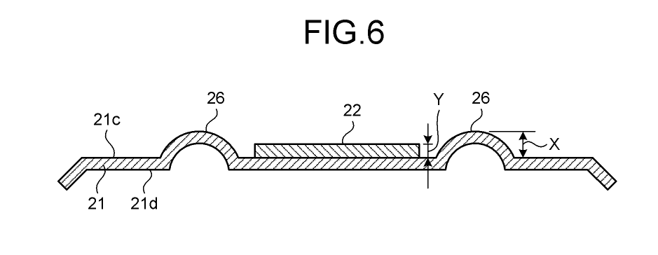

FIG. 5 is a plan view illustrating a schematic configuration of the load beam 21. FIG. 6 is a sectional view taken in an arrow direction of a line A-A shown in FIG. 4. The load beam 21 has a thin-plate shape extending from a base part 21a toward a distal end 21b. The load beam 21 is made of a metal such as stainless steel. In the plan view, the load beam 21 is formed in a line-symmetrical shape about a symmetrical axis 27 extending from the base part 21a toward the distal end 21b.

The slider 23 (also see FIG. 4) is provided near the distal end 21b of the load beam 21. A head element (not shown) is embedded in the slider 23. The head element includes a read element for reading data from the magnetic disk 6, and a write element for writing data on the magnetic disk 6. The read element is a magnetoresistive element, for example.

Referring back to FIG. 4, the flexure 22 is a flexible substrate having flexibility. The flexure 22 is formed in a layered structure having, for example, a stainless steel layer, a polyimide layer, and an electric wiring layer. A wire is formed using rolled copper or the like on the electric wiring layer. The flexure 22 is provided to be overlapped with a first surface 21c of the load beam 21 (also see FIG. 6). The flexure 22 is fixed to the first surface 21c of the load beam 21 by, for example, welding. The flexure 22 extends from the base part 21a toward the distal end 21b of the load beam 21.

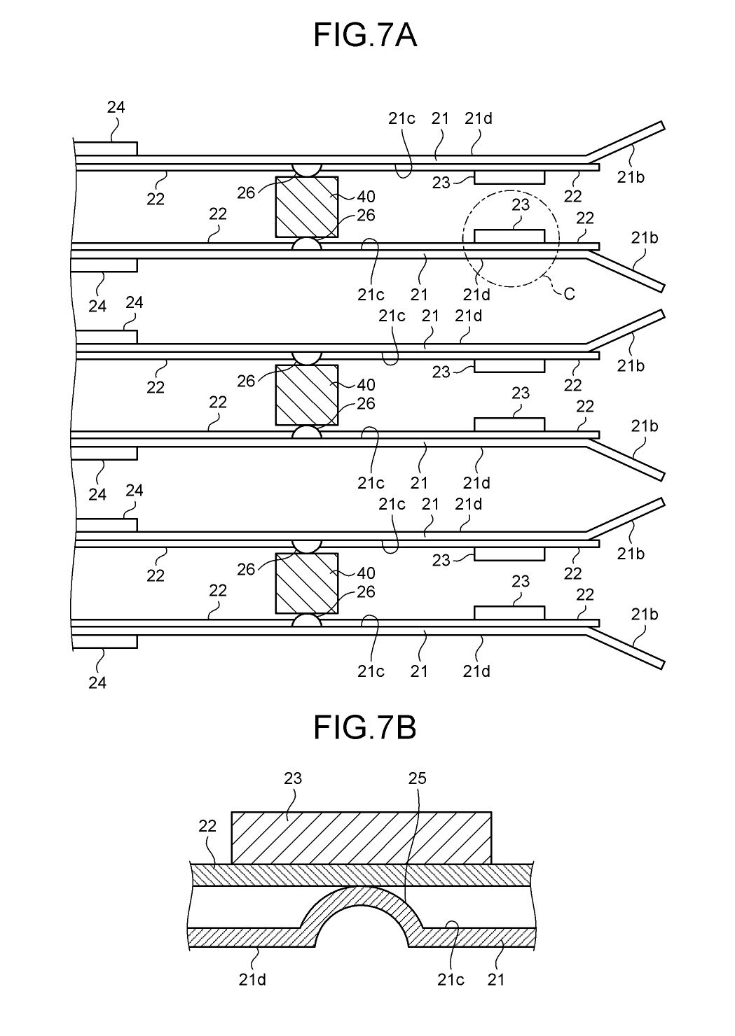

FIGS. 7A and 7B illustrate a schematic configuration of the head stack assembly, where FIG. 7A is a partially enlarged view of a part B shown in FIG. 3 and FIG. 7B is a partially enlarged sectional view of a part C shown in FIG. 7A. As shown in FIGS. 7A and 7B, the flexures 22 and the sliders 23 are arranged to be overlapped with each other on the first surfaces 21c at the distal ends of the load beams 21, respectively. That is, the sliders 23 are arranged on the flexures 22, respectively. The wire formed on the flexures 22 is electrically connected to the sliders. Power is supplied to the head elements via the wire formed in the flexures 22.

A protrusion 25 protruding on the first surface 21c side is formed in a portion where the slider 23 is arranged on the first surface 21c of the load beam 21. That is, the sliders 23 are arranged near the protrusions 25 formed on the load beams 21, with the flexures 22 interposed therebetween, respectively. Each of the sliders 23 maintains a posture suitable for writing and reading data to and from the magnetic disk 6, without abutting on the protrusion 25.

Referring back to FIG. 4, each of the base plates 24 is a plate member having a larger thickness than that of the load beam 21. The base plate 24 is made of a metal, for example. The load beam 21 is fixed to the base plate 24, for example, by welding on the side of the base part 21a. The flexure 22 is fixed to the base plate 24 by welding or bonding at a portion overlapped with the base plate 24.

Referring back to FIGS. 2, and 3, the head suspension assembly 20 is fixed to the arm 30 to form the head stack assembly 9. The base plates 24 are fixed to the arm 30 to fix the head suspension assembly 20 to the arm 30. The head stack assembly 9 includes at least a pair of head suspension assemblies 20 in which the first surfaces 21c of the load beams 21 face each other. In the present embodiment, three pairs of head suspension assemblies 20 in which the first surfaces 21c face each other are fixed to the arm 30. Accordingly, three pairs of sliders 23 facing each other are provided.

When write or read of data to or from the magnetic disk 6 is performed, the head stack assembly 9 changes the posture in the case 2 while inserting each of the magnetic disks 6 between the facing sliders 23. The head stack assembly 9 writes and reads data to and from each of the magnetic disks 6 inserted between the two sliders 23. Accordingly, in the magnetic disk drive 100 according to the present embodiment, three magnetic disks 6 are provided. When write or read of data is performed to or from the magnetic disks 6, the sliders 23 are positioned on the magnetic disks 6, respectively. At this time, the sliders 23 float from the corresponding magnetic disk 6 due to wind generated by rotation of the magnetic disk 6, thereby suppressing contacts between the sliders 23 and the magnetic disk 6.

When write or read of data to or from the magnetic disks 6 is not performed, the sliders 23 retract to a side of the magnetic disks 6. Lamps 32 are provided on the side of the magnetic disks 6. Each of the lamps 32 is inserted between the load beams 21 with the retracting operation of the sliders 23, thereby holding the gap between the sliders 23. Accordingly, the contacts between the sliders 23 can be suppressed, respectively.

A coil 31 is formed in the arm 30. The voice coil motor (the drive unit) 3 is formed by the coil 31 formed in the arm 30 and a magnet (not shown) provided in the case 2. The sliders 23 can be located at desired positions, respectively, by driving the voice coil motor 3 to move the head stack assembly 9 in the case 2.

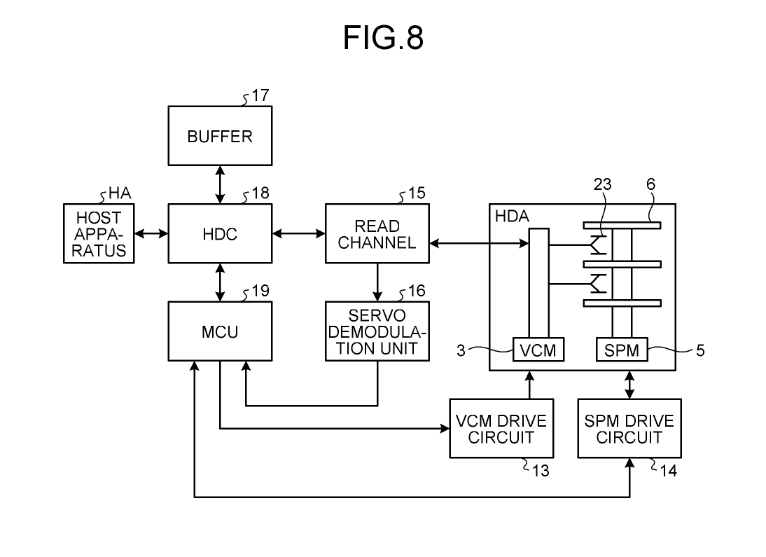

FIG. 8 is a block diagram illustrating a functional configuration of the magnetic disk drive. A hard disk controller (HDC) 18 controls an interface with a host apparatus HA for transmission/reception of various commands, data transmission/reception with the host apparatus HA, or the like and generates a control signal in the magnetic disk drive for controlling a recording/reproducing format on a magnetic disk medium. A buffer 17 is used for temporary storage of write data from the host apparatus HA, and temporary storage of read data from the magnetic disk 6.

A micro controller unit (MCU) 19 includes a microprocessor (MPU), a memory, a DA convertor, an AD convertor, and the like. The MCU 19 executes a servo control (a positioning control) for positioning the sliders 23 (the head elements) or the like. The MCU 19 executes a program stored in the memory to recognize a position signal from a servo demodulation unit 16, and calculates a control value of a VCM control current of the voice coil motor 3 for positioning. The MCU 19 controls the voice coil motor 3 via a VCM drive circuit 13 to execute the positioning control of the sliders 23 (the head elements). The MCU 19 also controls a drive current of an SPM drive circuit 14.

The VCM drive circuit 13 includes a power amplifier for causing the drive current to flow through the voice coil motor 3. The SPM drive circuit 14 includes a power amplifier for causing the drive current to flow through the spindle motor 5 that rotates the magnetic disks 6.

A read channel 15 is a circuit for performing recording and reproduction. The read channel 15 includes a modulation circuit and a parallel-serial conversion circuit for recording write data from the host apparatus HA on the magnetic disks 6, a demodulation circuit and a serial-parallel conversion circuit for reproducing data from the magnetic disks 6, and the like. Although not shown, a head IC having a write amplifier that supplies a recording current to the sliders 23 (the head elements), a preamplifier that amplifies a reproducing voltage from the sliders 23 (the head elements), and the like incorporated therein is provided in the magnetic disk drive 100.

Separators 40 each to be inserted between the load beams 21 at the time of manufacture of the head stack assembly 9 or in an inspection process thereof are explained next. As mentioned above, after the head stack assembly 9 is fitted in the case 2, the contacts between the sliders 23 are suppressed by floating from the magnetic disks 6 or holding the gaps between the load beams 21 with the lamps 32, respectively. The contacts between the sliders 23 need to be suppressed as well before the head stack assembly 9 is fitted in the case 2, that is, at the time of manufacture of the head stack assembly 9 and in the inspection process thereof.

Therefore, as shown in FIGS. 3 and 7, each of the separators 40 is inserted between the facing first surfaces 21c for avoiding the contacts between the sliders 23 until the head stack assembly 9 is fitted in the case 2. The separator 40 is made of a resin such as plastic. The gap between the load beams 21 is maintained and the contact between the sliders 23 is suppressed by inserting the separator 40.

Separation protrusions 26 provided for smoothly inserting the separators 40 between the load beams 21, respectively, in the head stack assembly 9 are explained next. Referring back to FIGS. 5 and 6, a plurality of separation protrusions 26 that protrude on the sides of the first surfaces 21c are formed on the load beams 21 at positions to avoid the flexures 22, respectively. The positions to form the separation protrusions 26 overlap with the position where the separators 40 are inserted, respectively.

The position where each of the separation protrusions 26 is formed is between the slider 23 and the base plate 24, as seen in a plan view. Particularly, in the present embodiment, each of the separation protrusions 26 is formed substantially in the middle between the slider 23 and the base plate 24. The separation protrusions 26 are formed at line-symmetric positions about the symmetrical axis 27. A protrusion height X of the separation protrusions 26 is larger than a thickness Y of the flexures 22.

The protrusion height X of each of the separation protrusions 26 is equal to or less than one third the distance between the first surface 21c of the corresponding load beam 21 and an air bearing surface (ABS) of the corresponding slider 23. The surfaces of the separation protrusions 26 have spherical shapes, respectively. On a second surface 21d, which is the opposite surface to the first surface 21c of the load beam 21, the opposite sides to the separation protrusions 26 are concave.

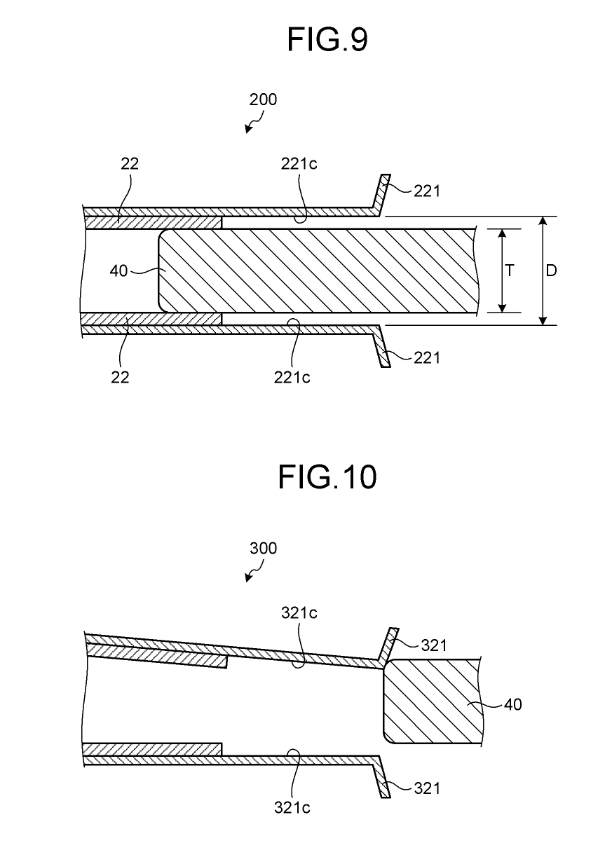

FIG. 9 illustrates a state where the separator 40 is inserted between load beams 221 in a head stack assembly 200 shown as a comparative example. The separation protrusions 26 are not formed on first surfaces 221c of the load beams 221. In this case, the separator 40 inserted between the load beams 221 comes in contact with the flexures 22 provided on the first surfaces 221c. By further inserting the separator 40 in the state with the separator 40 and the flexures 22 in contact with each other, dust (contamination) is likely to be generated due to frictions between the separator 40 and the flexures 22. Generation of dust (contamination) may cause deterioration in reliability of the magnetic disk drive, such as head crash.

FIG. 10 illustrates a state where the separator 40 is inserted between load beams 321 in a head stack assembly 300 shown as another comparative example. The separation protrusions 26 are not formed on first surfaces 321c of load beams 321. An inclination as shown in FIG. 10 may be generated in the load beams 321 due to an installation error of the load beams 321 to the base plates 24 (see FIG. 4 and the like) or the arm 30 (see FIG. 2 and the like), or the like.

Because the inclination is generated in the load beams 321, a gap between ends of the load beams 321 may become narrower than a case of having no inclination. Therefore, the separator 40 to be inserted between the load beams 321 is likely to hit the ends of the load beams 321. The load beams 321 deform due to hits of the separator 40 against the ends of the load beams 321, and thus performance deterioration of the magnetic disk drive or decrease in the manufacturing yield thereof may be caused.

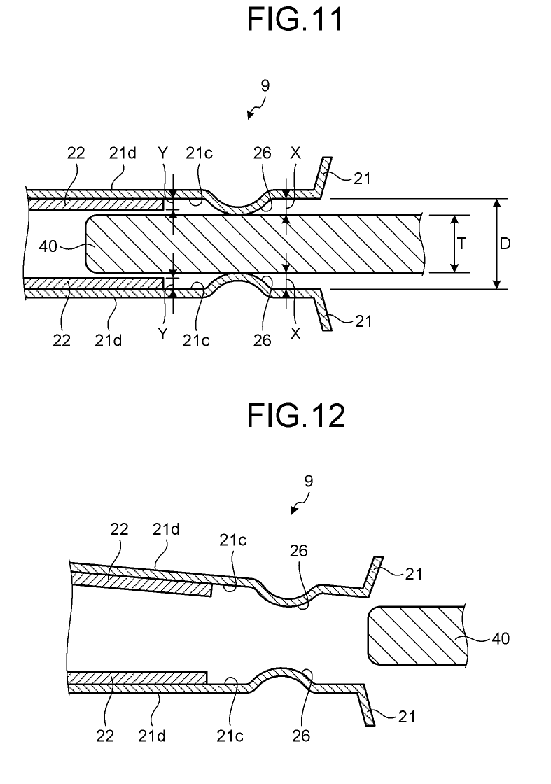

FIG. 11 illustrates a state where the separator 40 is inserted between the load beams 21 in the head stack assembly 9 according to the first embodiment. In the present embodiment, because the separation protrusions 26 are formed on the first surfaces 21c of the load beams 21, the separator 40 does not easily come in contact with the flexures 22. In the present embodiment, because the height of the separation protrusions 26 is larger than the thickness of the flexures 22, the contacts between the separator 40 and the flexures 22 can be prevented more reliably. Accordingly, generation of dust (contamination) due to frictions between the separator 40 and the flexures 22 is suppressed, and reliability of the magnetic disk drive 100 can be improved.

Furthermore, because the surfaces of the separation protrusions 26 have the spherical shapes, respectively, contact areas between the separation protrusions 26 and the separator 40 can be minimized. By minimizing the contact areas between the separation protrusions 26 and the separator 40, generation of dust (contamination) due to frictions between the separation protrusions 26 and the separator 40 can be suppressed, thereby improving the reliability of the magnetic disk drive 100.

FIG. 12 illustrates a state where the separator 40 is inserted between the load beams 21 in the head stack assembly 9 according to the first embodiment. If the separation protrusions 26 are not formed as in the comparative examples, the gap between the load beams 21 needs to be held by the thickness of the separator 40. Accordingly, when it is assumed that a required gap between the load beams 21 is D and the thickness of the separator 40 is T, a relation of D≅T needs to be maintained.

Besides, according to the present embodiment, the gap between the load beams 21 can be held by the thickness T of the separator 40 and the height X of the separation protrusions 26. Accordingly, it suffices to meet D≅T+2 X. That is, the separator 40 can be thinner.

Therefore, even if the load beams 21 incline and the gap between the ends of the load beams 21 becomes narrow as shown in FIG. 12, the thin separator 40 can be inserted smoothly. Accordingly, hits of the separator 40 against the load beams 21 are suppressed, and thus the reliability of the magnetic disk drive 100 can be improved.

According to the present embodiment, because the separation protrusions 26 are formed on both of the facing first surfaces 21c and formed at facing positions (positions overlapping with each other as seen in a plan view), respectively, it suffices to meet D≅T+2 X. Even when the separation protrusion 26 is formed only on one of the first surfaces 21c or when the separation protrusions 26 formed on the facing first surfaces 21c are formed at unaligned positions (at the positions not overlapping with each other as seen in a plan view), respectively, D≅T+X can be achieved and thus the separator 40 can be formed thinner than in the comparative examples.

According to the present embodiment, the load beams 21 are formed in line-symmetrical shapes about the symmetrical axis 27 extending from the base part 21a toward the distal end 21b, and the separation protrusions 26 are also formed at line-symmetrical positions about the symmetrical axis 27, respectively. Therefore, when the same load beams 21 are attached to overlap with each other as seen in a plan view with one of the load beams 21 turned back, the head stack assembly 9 in which the separation protrusions 26 face each other can be acquired. Accordingly, the shapes of the load beams 21 provided in the head stack assembly 9 can be uniform. This can suppress the manufacturing cost because of reduction in the number of components.

Furthermore, if the separation protrusions 26 are too close to the base plates 24, the separator 40 is away from the distal end 21b, and the sliders 23 are likely to come in contact with each other due to deflection of the load beams 21. Furthermore, due to deflection of the load beams 21, the gap on the distal ends 21b tends to be narrow. Therefore, the separator 40 is likely to hit the ends of the load beams 21 at the time of inserting the separator 40 if the separation protrusions 26 are too close to the sliders 23. In contrast, in the present embodiment, because each of the separation protrusions 26 is formed substantially in the middle between the slider 23 and the base plate 24, such a problem hardly occurs.

Further, because the opposite sides to the separation protrusions 26 are concave, respectively, the separation protrusions 26 can be easily formed by press working. However, the opposite sides to the separation protrusions 26 do not need to be concave, and the separator 40 can be smoothly inserted between the load beams 21 so long as the load beams 21 protrude on the sides of the first surfaces 21c.

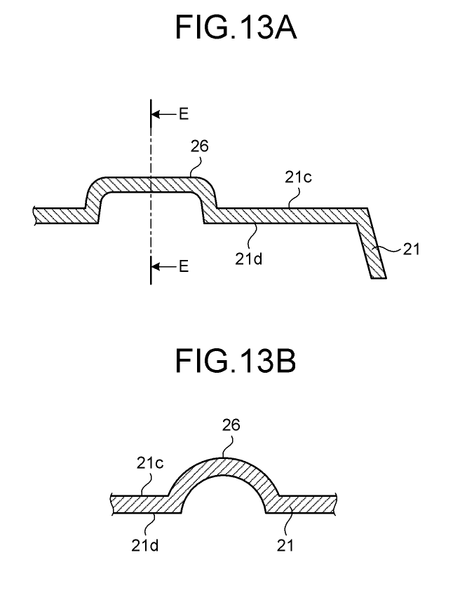

FIGS. 13A and 13B illustrate a modification of the separation protrusion 26, where FIG. 13A is a side view of the separation protrusion 26 and FIG. 13B is a sectional view taken in an arrow direction of a line E-E shown in FIG. 13A. As shown in FIGS. 13A and 13B, the surface of the separation protrusion 26 can be formed to have a cylindrical shape portion. Also in the modification shown in FIGS. 13A and 13B, the opposite side to the separation protrusion 26 can be concave or not concave.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A suspension assembly comprising:
a load beam having thin plate-like shape, the load beam extending from a base part toward a distal end; and
an electric wiring member that extends from the base part toward the distal end to be overlapped with a first surface of the load beam and that includes a wire formed thereon; wherein
a protrusion that protrudes on the first surface side is provided at a position avoiding the electric wiring member on the load beam, as seen in a plan view.

2. The suspension assembly according to claim 1, wherein a height of the protrusion is larger than a thickness of the electric wiring member.

3. The suspension assembly according to claim 1, wherein
the load beam is formed in a symmetrical shape about an axis extending from the base part toward the distal end as seen in a plan view, and
a plurality of the protrusions are provided and formed at symmetrical positions about the axis, respectively.

4. The suspension assembly according to claim 1, wherein an opposite side to the protrusion is concave on a second surface that is an opposite surface to the first surface.

5. The suspension assembly according to claim 1, wherein a surface of the protrusion has a spherical shape.

6. The suspension assembly according to claim 1, wherein a surface of the protrusion has a cylindrical shape portion.

7. The suspension assembly according to claim 1, further comprising a base plate to which the base part of the load beam is fixed, wherein
the protrusion is formed between a portion where a slider having a head element is to be provided on the electric wiring member and the base plate.

8. The suspension assembly according to claim 7, wherein the protrusion is formed substantially in a middle between the portion where the slider is provided and the base plate.

9. A head suspension assembly comprising:
a slider having a head element; and
the suspension assembly according to claim 1 that includes the slider.

10. The head suspension assembly according to claim 9, wherein a height of the protrusion is larger than a thickness of the electric wiring member.

11. The head suspension assembly according to claim 9, further comprising a base plate to which the base part of the load beam is fixed, wherein
the protrusion is formed between a portion where the slider is provided on the electric wiring member and the base plate.

12. The head suspension assembly according to claim 11, wherein the protrusion is formed substantially in a middle between the portion where the slider is provided and the base plate.

13. A magnetic disk drive comprising:
a case;
a magnetic disk housed in the case; and
a head suspension assembly that faces the magnetic disk, wherein
the head suspension assembly includes:
an arm;
a base plate fixed to the arm;
a load beam fixed to the base plate and extends from a base part toward a distal end;
an electric wiring member that extends from the base part toward the distal end to be overlapped with a first surface of the load beam and on which a wire is formed; and
a slider provided on the electric wiring member and has a head element for performing write or read of data to or from the magnetic disk, and
a protrusion that protrudes on the first surface side being provided at a position avoiding the electric wiring member on the load beam, as seen in a plan view.

14. The magnetic disk drive according to claim 13, wherein a height of the protrusion is larger than a thickness of the electric wiring member.

15. The magnetic disk drive according to claim 13, wherein
the load beam is formed in a symmetrical shape about an axis extending from the base part toward the distal end as seen in a plan view, and
a plurality of the protrusions are provided and formed at symmetrical positions about the axis, respectively.

16. The magnetic disk drive according to claim 13, wherein an opposite side to the protrusion is concave on a second surface that is an opposite surface to the first surface.

17. The magnetic disk drive according to claim 13, wherein a surface of the protrusion has a spherical shape.

18. The magnetic disk drive according to claim 13, wherein a surface of the protrusion has a cylindrical shape portion.

19. The magnetic disk drive according to claim 13, wherein the protrusion is formed between the slider and the base plate.

20. The magnetic disk drive according to claim 13, further comprising a head stack assembly that includes a plurality of the head suspension assemblies, wherein
the protrusions formed on a plurality of the load beams, respectively, provided in the head suspension assemblies included in the head stack assembly face each other.
